(19) United States
(12) Patent Application Publication
(10) Pub. No.: US 2024/0150917 A1
(43) Pub. Date: May 9, 2024

(54) ELECTROLYTE SUPPLY STRUCTURE FOR PROVIDING UNIFORM FLUID FLOW FOR LARGE ALKALINE HYDROGEN ELECTROLYZERS

(71) Applicant: Haiming Li, Quincy, MA (US)

(72) Inventor: Haiming Li, Quincy, MA (US)

(21) Appl. No.: 17/981,189

(22) Filed: Nov. 4, 2022

(51) Int. Cl. C25B 15/08; C25B 1/04; C25B 11/036

(52) U.S. Cl. CPC C25B 15/08; C25B 1/04; C25B 11/036

(57) ABSTRACT

The invention relates to water-electrolysis hydrogen production technology, in particular to electrolyte supply structure for providing uniform fluid flow for large alkaline hydrogen electrolyzers. The electrolyte supply structure includes a bipolar electrode frame that has an electrolyzer cell inside, an outlet located at the top, and three inlets (a first inlet, a second inlet, and a third inlet) located at the left, middle, and right of the bottom, wherein the third inlet having a barrier plate located at the left inside. This invention, by setting the three inlets replacing the original two inlets and adjusting the inlets' width, quantities, and inlets' angles, effectively increases the uniformity of fluid flow inside the cell, improves performance, and has no influence on mechanical processing and cost.

### TECHNICAL FIELD

The invention relates to the technical field of water-electrolysis hydrogen production, in particular to a water-electrolysis hydrogen production electrolytic cell electrolyte supply structure.

### BACKGROUND AND PRIOR ART

The industrial alkaline water-electrolysis hydrogen production electrolyzer generally comprises a plurality of stacked electrolysis cells. The required lye is usually provided by one or several lye inlets. Such a liquid supply structure is suitable for small and medium electrolyzers. However, with the enlargement of the alkaline electrolyzer and increased cell dimensions of the alkaline electrolytic cell, it is found through computational fluid dynamics analysis that the electrolyte supply structure suitable for small and medium-sized electrolytic cells will not be able to ensure the uniformity of the flow field in the cell of the electrolytic cell, thereby causing the local gas concentration in the cell to increase, affecting the reaction rate, and ultimately affecting the performance cell of the electrolyzer.

In addition, the electrochemical reaction inside the alkaline electrolyzer will release heat and cause the electrode temperature to rise. The temperature of the electrolyzer can be maintained within a certain range through lye circulation and lye cooling. However, the non-uniformity of the flow field inside the electrolytic cell will make the local heat dissipation effect of the electrode in the small cell of the electrolytic cell poor, and the temperature distribution will be uneven, which will affect the operating performance of the electrolytic cell, shorten the service life, and also have potential safety hazards. With the increase of the electrolytic cell volume and reaction area, the inhomogeneous flow field inside the electrolytic cell becomes more significant.

At this stage, in the technical field of the internal structure of alkaline water electrolysis hydrogen production electrolyzers, no relevant patents have been found to involve the design of electrolyte supply structures based on computational fluid dynamics analysis. Therefore, how to design a new electrolyte supply structure through computational fluid dynamics analysis, improve the performance of alkaline water electrolysis hydrogen production electrolyzers, and eliminate potential safety hazards is an urgent problem to be solved by those skilled in the art.

### INTRODUCTION TO THE INVENTION

The purpose of the invention is to provide an electrolyte supply structure for water-electrolysis hydrogen production electrolyzers; in order to solve the problem of the non-uniform low-flow zone inside the electrolytic cells proposed in the background as mentioned above technology, which affects the performance of the electrolyzer.

### SUMMARY

To achieve the above object, the present invention provides the following technical solutions:

An electrolyte supply structure for providing uniform fluid flow for large alkaline hydrogen electrolyzers comprises a bipolar plate frame, an electrolytic inner cell is arranged on the inner side of the bipolar plate frame, an outlet is provided on the outer upper end of the bipolar plate frame, and the bipolar plate frame is provided with an outlet. A first inlet is located at the right side of the outer lower end of the bipolar plate frame, a second inlet is located at the middle of the outer lower end of the bipolar plate frame, and a third inlet is located at the left side of the outer lower end of the bipolar plate frame, the left side of the inner wall of the third inlet is provided with a baffle.

Preferably, the inner dimension of the first inlet groove is smaller than the inner dimension of the second inlet groove, and the inner dimension of the second inlet groove is smaller than that of the third inlet.

Preferably, the lower end of the barrier plate is rotatably connected to the lower end of the inner side of the bipolar plate frame, the upper end of the barrier plate is fixedly connected with a sliding block, and the sliding block is composed of a rubber block. The upper end of the sliding block is connected to the electrolysis cell. The inner wall of the cavity is in a sliding connection.

Preferably, an elastic frame is slidably connected to the inner lower end of the bipolar plate frame, the adjustable frame is arranged in a Z shape, and the other end of the adjustable frame is slidably connected to the baffle.

Preferably, a first fixing ring is fixedly connected to the outer upper end of the adjustable frame, the right end of the first fixing ring is fixedly connected to the left side of the baffle, and the adjustable frame is composed of a deformable metal rod.

Preferably, a second fixing ring is fixedly connected to the lower end of the outer side of the elastic frame, and the lower end of the second fixing ring is fixedly connected to the inner side of the bipolar plate frame.

Compared with the prior art, the beneficial effects of the present invention model are:

In the invention, the first inlet, the second inlet, the set of baffles, and the third inlet are provided, and the original two inlets are increased to three. The inner dimension and quantity of the grooves and the angle of the inlet are changed to eliminate the non-uniform low-flow zone and enhance the uniformity of heat dissipation, thereby improving the performance of the electrolyzer without affecting the machining and cost.

### BRIEF DESCRIPTION OF THE FIGURES

FIG. 1 is the overall structure schematic diagram of the present invention;

FIG. 2 is the partial sectional view of the structure schematic diagram of FIG. 1 of the present invention;

FIG. 3 is a schematic diagram of the structure at A of FIG. 2 of the present invention.

In the figure: 1—bipolar plate frame, 2—electrolytic cell, 3—outlet, 4—first inlet, 5—the second inlet, 6—third inlet, 7—baffle, 8—sliding block, 9—Elastic frame, 10—first fixing ring, 11—second fixing ring.

### DETAILED DESCRIPTION OF EXAMPLE EMBODIMENTS

The technical solutions in the embodiments of the present invention will be clearly and completely described below regarding the drawings in the embodiments of the present invention. Obviously, the described embodiments are only a part of the embodiments of the present invention rather than all the embodiments. Based on the embodiments of the present invention, all other embodiments obtained by those of ordinary skill in the art without creative work fall within the protection scope of the present invention.

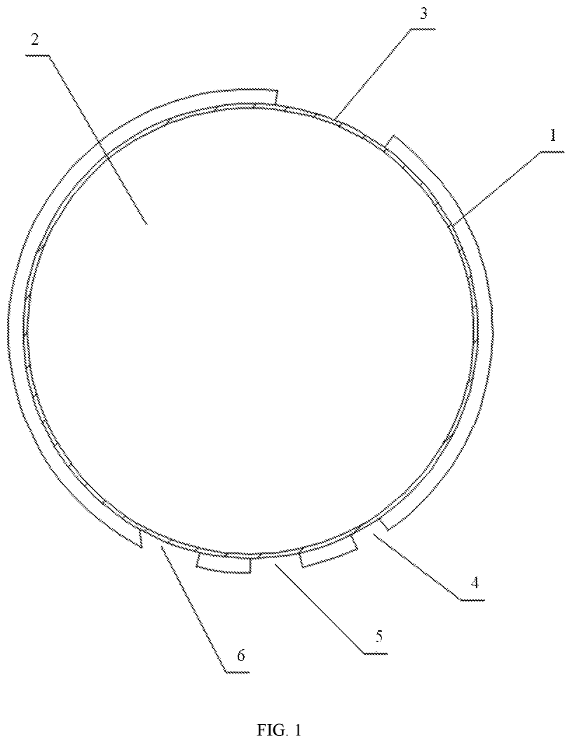

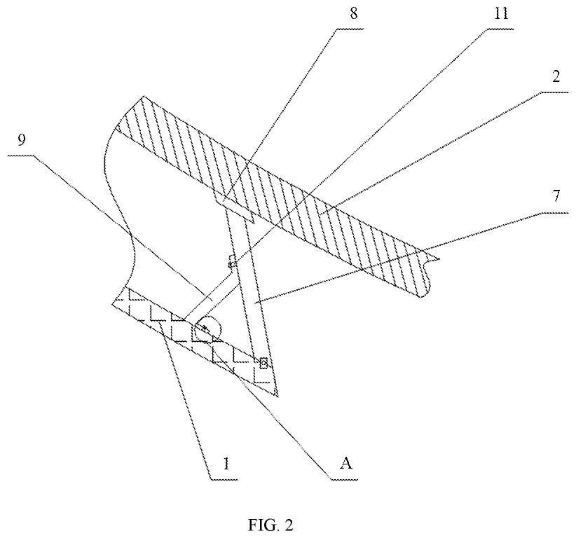

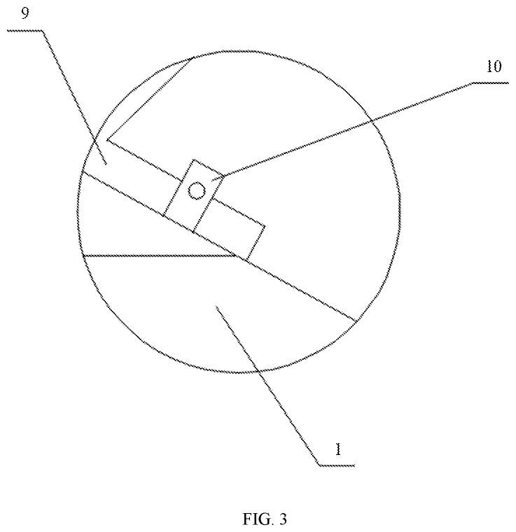

Referring to FIGS. 1-3, the present invention provides a technical solution:

An electrolyte supply structure of a water-electrolysis hydrogen production electrolyzer comprises a bipolar plate frame 1, and the inside of the bipolar plate frame 1 is provided with an electrolytic cell 2. The outer upper end of the bipolar plate frame 1 is provided with an outlet 3, the right side of the lower end of the outer side of the bipolar plate frame 1 is provided with a first inlet 4, the middle of the lower end of the outer side of the bipolar plate frame 1 is provided with a second inlet 5, and the left side of the lower end of the outer side of the bipolar plate frame 1 is provided with The third inlet 6, the left side of the inner wall of the third inlet 6 is provided with a baffle 7, the inner diameter of the groove of the first inlet 4 is smaller than the inner diameter of the groove of the second inlet 5, and the inner diameter of the groove of the second inlet 5 is smaller than that of the third inlet 6. By adding a baffle, the lower end of 7 is rotationally connected with the lower end of the inner side of the bipolar plate frame 1. By increasing the inlet of the bipolar plate frame 1, changing the inner diameter and quantity of the inlet slot, and changing the angle of the inlet, the non-uniform low-flow zone can be effectively minimized, and the performance can be improved. And it has no impact on machining and cost.

The upper end of baffle 7 is fixedly connected with sliding block 8, which is composed of a rubber block. The flexible frame 9 is arranged in a Z shape, the other end of the flexible frame 9 is slidably connected with the baffle 7, the outer upper end of the flexible frame 9 is fixedly connected with the first fixing ring 10, and the right end of the first fixing ring 10 is connected with The left side of the baffle plate 7 is fixedly connected, the flexible frame 9 is composed of a deformable metal rod, the outer lower end of the elastic frame 9 is fixedly connected with a second fixing ring 11, and the lower end of the second fixing ring 11 is connected to the bipolar plate pole frame 1. The inner side is fixedly connected, and the deformable elastic frame 9 is fixed and supported by the first fixing ring 10 and the second fixing ring 11, and the flexible frame 9 supports the baffle 7, so that the baffle 7 and The bipolar plate frame 1 rotates, the sliding block 8 slides on the inside, and the baffle 7 squeezes the elastic rod 9, thereby changing the inlet angle during flow.

When the present invention is in use, the original two larger inlets of the bipolar plate frame 1 are added to the first inlet 4, the second inlet 5, and the third inlet 6, and the inner dimension of the groove of each inlet is different. During the electrolyte flow, the dimension of the first inlet 4 is smaller than that of the second inlet 5. The dimension of the second inlet 5 is smaller than that of the third inlet 6, so the electrolyte passes through the first inlet 4, the second inlet 5, and the third inlet 6 at different speeds so that the flow angle of fluid in the electrolysis cell 2 is more diverse, and the non-uniform low-flow area in the electrolysis cell 2 is decreased. The impulsive force is in contact with the blocking plate 7, the impulsive force can make the blocking plate 7, and the bipolar plate frame 1 rotate, the sliding block 8 slides on the inside, and the baffle 7 squeeze the elastic rod 9, thereby changing the inlet angle during flow, so that the electrolysis The fluid inside the cell 2 flows uniformly, thereby effectively eliminating the low flow rate area and improving the effectiveness of water-electrolysis in the electrolyzer for hydrogen production.

Although embodiments of the present invention have been shown and described, it will be understood by those skilled in the art that various changes, modifications, and substitutions can be made in these embodiments without departing from the principle and spirit of the invention and modifications, the appended claims and their equivalents define the scope of the invention.

What is claimed is:

1. An electrolyte supply structure for providing uniform fluid flow for large alkaline hydrogen electrolyzers comprising a bipolar plate frame, wherein an electrolytic chamber is arranged inside the bipolar plate frame, the outer upper end of the bipolar plate frame is provided with an outlet, and the right side of the outer lower end of the bipolar plate frame is provided with a first inlet; the second inlet is located at the middle of the lower end of the outer side, and a third inlet is located at the left side of the lower end of the outer side of the bipolar plate frame, and a baffle is arranged on the left side of the inner wall.

2. The structure of claim 1, wherein the inner dimension of the first inlet groove is smaller than the inner dimension of the second inlet groove, and the inner dimension of the second inlet groove is smaller than the inner dimension of the third inlet groove.

3. The structure of claim 1, wherein the lower end of the baffle is rotatably connected to the inner lower end of the bipolar plate frame, a sliding block is fixedly connected to the upper end of the baffle, sliding block is composed of a rubber block, and the upper end of the sliding block is in sliding connection with the inner wall of the electrolysis chamber.

4. The structure of claim 1, wherein a flexible frame is slidably connected to the inner lower end of the bipolar plate frame, the flexible frame is arranged in a Z-shape, and the other end of the flexible frame is slidably connected to the baffle.

5. The structure of claim 4, wherein the outer upper end of the flexible frame is fixedly connected with a first fixing ring, the right end of the first fixing ring is fixedly connected with the left side of the baffle, and the flexible frame is composed of a deformable metal rod.

6. The structure of claim 4, wherein the second fixing ring is fixedly connected to the lower end of the outer side of the flexible frame, and the lower end of the second fixing ring is fixedly connected to the inner side of the bipolar plate frame.
